(19) United States
(12) Patent Application Publication
(10) Pub. No.: US 2009/0302491 A1
(43) Pub. Date: Dec. 10, 2009

(54) EXTRUSION DIE WITH EXTRUSION PORT HAVING A SHAPED EXTRUSION OUTLET

(75) Inventor: Thomas B. HUNTER, Collinsville, IL (US)

Correspondence Address: BIRCH STEWART KOLASCH & BIRCH, PO BOX 747, FALLS CHURCH, VA, 22040-0747, US

(73) Assignee: KERRY, INC., Beloit, WI (US)

(21) Appl. No.: 12/436,466

(22) Filed: May 6, 2009

Related U.S. Application Data
(60) Provisional application No. 61/071,570, filed on May 6, 2008.

(51) Int. Cl. A21C 11/16; B29C 47/00

(52) U.S. Cl. 264/148; 425/311

(57) ABSTRACT

A cutter assembly for an extruder includes an elongated extrusion member having an open feed end. The open feed end is attachable in fluid communication with the extruder for supplying a mash thereto. An extrusion die is supported on the elongated extrusion member. The extrusion die includes at least one extrusion outlet formed therein. A cutter member cuts extrudate to a desired length as the extrudate exits the die. The at least one extrusion outlet is shaped to have at least six straight sides, the shape of the at least one extrusion outlet ensuring that the mash exits the extrusion die in a straight orientation in order to form a straight food product.

### CROSS-REFERENCE TO RELATED APPLICATION

This Non-provisional application claims priority under 35 U.S.C. § 119(e) on U.S. Provisional Application No. 61/071,570 filed on May 6, 2008, the entire contents of the above application is hereby incorporated by reference into the present application.

### BACKGROUND OF THE INVENTION

1. Field of the Invention

The present invention relates to an extrusion die for a cutter assembly of an extruder for extruding stick shaped food pieces. More particularly, the present invention relates to an extruder cutter assembly, which includes an extrusion die having an extrusion port that is shaped to make sure that the food pieces stay straight when exiting the extrusion die.

2. Description of Background Art

Extruders for producing extruded food pieces are known. Such extruders can conventionally include a pressure vessel for containing, under pressure, a mash of the food to be extruded. Furthermore, pressure exerting means for maintaining pressure in the pressure vessel, a manifold in fluid communication with the pressure vessel, and a cutter assembly, generally located underneath the pressure vessel, in fluid communication with the manifold can be included. The extruder cutter assembly cuts the extruded food to size. An extruder of the above type is disclosed, for example in U.S. Pat. No. 5,773,043 to Hunter (hereinafter “the '043 patent”). The '043 patent is hereby incorporated by reference.

Food products that can be extruded in such extruders include, e.g., meats, poultry, seafood, cereal grains, vegetables, fruits, and solid dairy products. As specific examples, the mash may be prepared from beef, chicken, shrimp, wheat, corn, rice, potatoes, apples, and cheese.

The food is ground to a particle size consistent with forming a fluid mash, e.g., particle sizes that will pass through a U.S. Screen Series No. 5 screen, more usually a No. 10 screen, and often a No. 20 screen up to about a No. 100 screen.

Water or other dispersing liquids, e.g., 3% to 70%, may be added to the ground food in order to produce a liquid mash. Binders, flavors, preservatives, colors, stabilizers, antioxidants, and the like may be added to the mash, in conventional amounts. Most often, a gelling material is added to the mash, e.g., a settable gum or pectate, for example, guar gum and sodium alginate, in conventional amounts of about 0.1% to 25%. The gum or pectate is set by a gelling agent, e.g., a 0.5% to 10% solution of calcium chloride and sodium alginate.

In the '043 patent, an extruder cutter assembly extrudes a food piece in the shape of a natural food piece. The extruder cutter assembly includes an extrusion member and a tubular cutter member for cutting extrudate exiting the extrusion member. However, the '043 patent does not include a die having a shaped extrusion port that makes sure that the food pieces are maintained in a straight orientation when exiting the die as in the present invention.

The present inventor has also invented an extruder cutter assembly for extruding foodstuff containing a filling. In U.S. Pat. Nos. 6,511,309 and 6,964,562 (hereinafter “the '309 patent” and “the '562 patent”, respectively), an extruder cutter assembly includes a filling tube or passageway for extruding a filling along with the mash of food to form a filled food product. An extension is formed on the extrusion member and the cutter member to allow for the extrudate to exit the extruder cutter assembly from the side. This extension to the extrusion member and cutter member is similar to the present invention. However, the extruder cutter assembly in the '309 patent and the '562 patent does not include a die having a shaped extrusion port that makes sure that the food pieces maintain a straight orientation when exiting the die as in the present invention. The '309 patent and the '562 patent are hereby incorporated by reference.

The present inventor has also invented an extrusion die with extrusion ports having a shaped extrusion outlet (see U.S. Application Publication No. 2008/0241327, filed on Feb. 20, 2008, which is hereby incorporated by reference). The Extrusion die has shaped extrusion ports, which in conjunction with the pressure of the mash exiting the die, makes the extrudate twist to form a twisted product.

### SUMMARY OF THE INVENTION

It is an object of the present invention to provide a cutter assembly for an extruder, which makes up for the above deficiencies of the background art. Specifically, it is an object of the present invention to provide an extruder cutter assembly, which can form an extruded product that is straight when exiting the extrusion die.

In order to accomplish the above objects of the present invention, a cutter assembly for an extruder comprises:

an elongated extrusion member having an open feed end, said open feed end being attachable in fluid communication with the extruder for supplying a mash to said elongated extrusion member;

an extrusion die supported on said elongated extrusion member, said extrusion die including at least one extrusion outlet formed therein; and

a cutter member having a drivable end and a cutter blade with a cutting surface for cutting extrudate to a desired length as the extrudate exits the extrusion die, said cutter member being operably connectable at the drivable end to a drive device of the extruder for reciprocatably sliding the cutting surface of the cutter blade over and away from the outlet of the extrusion die,

wherein said at least one extrusion outlet is shaped to have at least six straight sides, the shape of the at least one extrusion outlet ensuring that the mash exits the extrusion die in a straight orientation in order to form a straight food product.

In addition, the above objects of the present invention can be accomplished by a method of making a straight food product, said method comprising the steps of:

providing an elongated extrusion member having an open feed end, said open feed end being attachable in fluid communication with an extruder for supplying a mash to said elongated extrusion member;

providing an extrusion die supported on said elongated extrusion member, said extrusion die including at least one extrusion outlet formed therein, said at least one extrusion outlet being shaped to have at least six straight sides, the shape of the at least one extrusion outlet ensuring that the mash exits the extrusion die in a straight orientation in order to form a straight food product;

providing a cutter member having a drivable end and a cutter blade with a cutting surface for cutting extrudate to a desired length as the extrudate exits the extrusion die, said cutter member being operably connectable at the drivable end to a drive device of the extruder for reciprocatably sliding the cutting surface of the cutter blade over and away from the outlet of the extrusion die; and

extruding the mash while ensuring that the mash maintains a straight orientation to form a straight food product.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

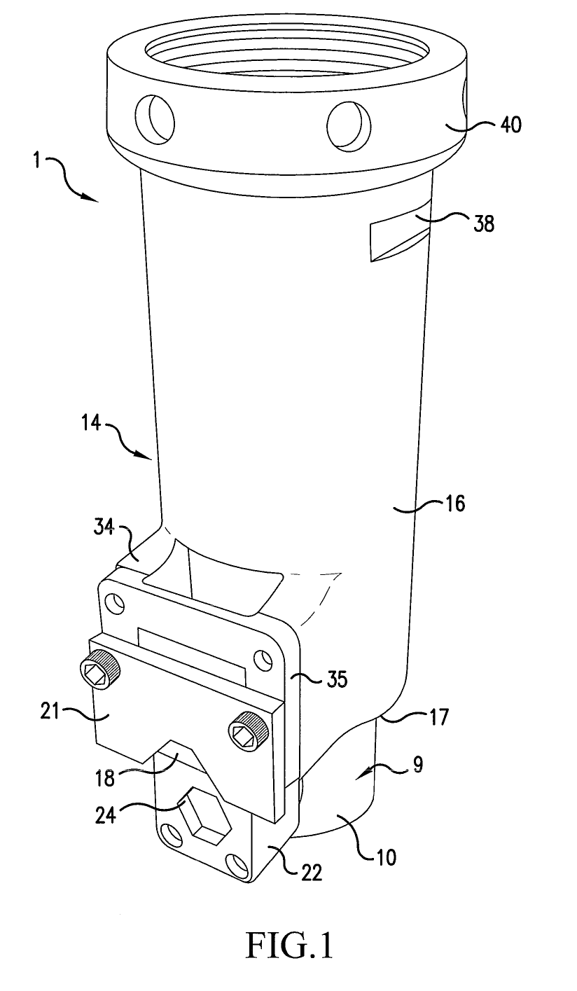

FIG. 1 is a perspective view of the extruder cutter assembly of the present invention;

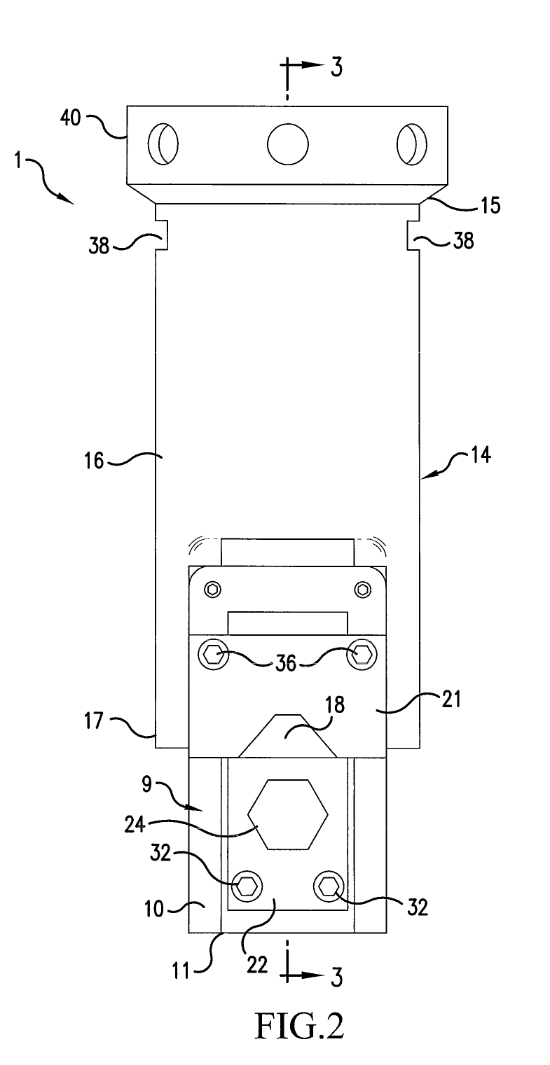

FIG. 2 is a front elevation of the extruder cutter assembly of the present invention illustrating the “ready to cut” state;

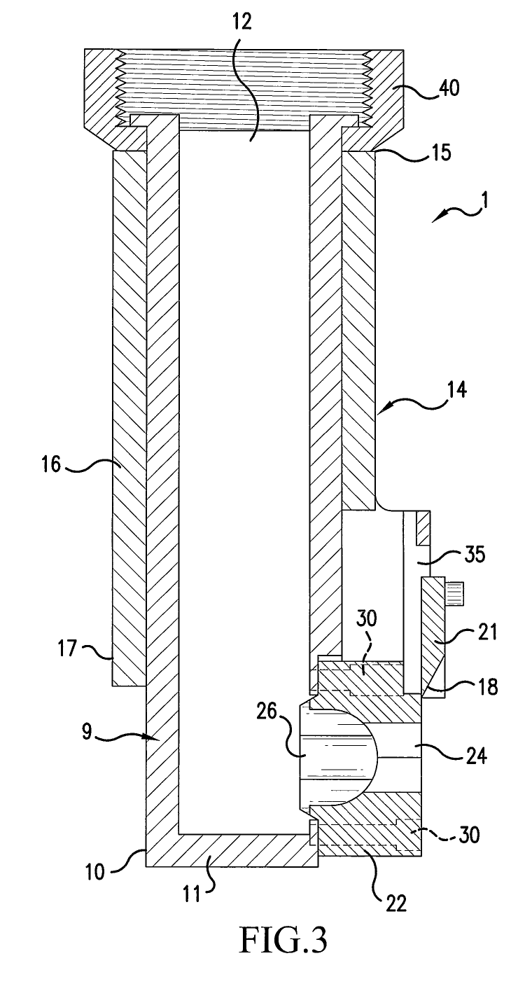

FIG. 3 is a cross-section of the extruder cutter assembly of the present invention along line 3-3 of FIG. 2;

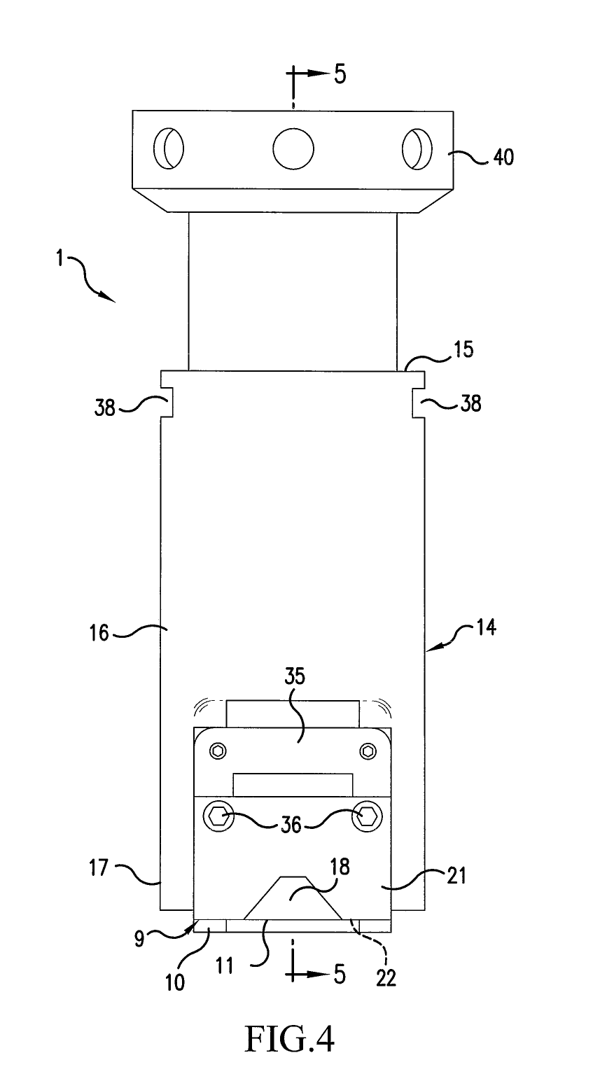

FIG. 4 is a front elevation of the extruder cutter assembly of the present invention illustrating the “after cut” state; and

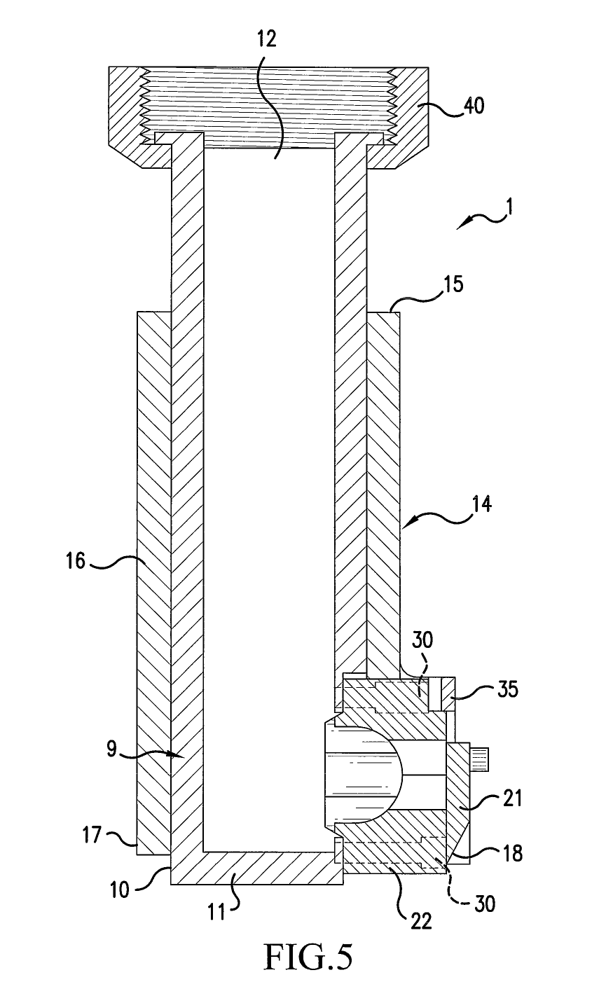

FIG. 5 is a cross-section of the extruder cutter assembly of the present invention along line 5-5 of FIG. 4;

### DETAILED DESCRIPTION OF THE INVENTION

The present invention will now be described with reference to the accompanying drawings, wherein the same or similar elements are identified by the same reference numeral.

FIGS. 1 and 2 illustrate the die and cutter assembly of the present invention in the “ready to cut” state. Referring to FIGS. 1-2, the die and cutter assembly of the present invention 1 includes an elongated annular extrusion member 9 having a generally tubular extrusion wall 10. An extrusion end cap 11 is connected to the extrusion wall 10 close to a bottom end of the annular extrusion member 9 and an open feed end 12 (see FIG. 3) is formed adjacent an upper end of the extrusion member 9.

The die and cutter assembly of the present invention is attachable to an extruder, such as the extruder described in U.S. Pat. No. 5,773,043, the entirety of which is hereby incorporated by reference, and will therefore not be described in detail. The open feed end 12 is attachable in fluid communication to a manifold (not shown) by, for example, a threaded flange 40. The manifold is connectable to a pressure vessel (not shown) for containing a mash under pressure by a pressure-asserting device (not shown).

The extrusion member includes a die 22 mounted to the extrusion member 9 at a side surface thereof by, for example, a plurality of screws 32 which extend through respective holes 30 formed in the die (see FIGS. 2 and 3). The die 22 cooperates with a cutting element 21 of a cutter member as will be described hereinbelow.

The die and cutter assembly of the present invention 1 also includes a tubular cutter member 14 having an open drivable end 15, an elongated cutter wall 16, and an open cutter end 17. The cutter wall 16 includes a housing or extension 34 formed thereon for supporting a cutting element 21. The cutting element 21 includes a cutting surface 18 for cooperating with the extrusion die 22 to cut and crimp extrudate to a desired length as the extrudate exits extrusion die 22. The cutting element 21 is mounted to a face plate 35 mounted on the extension 34 by a plurality of screws 36. The cutting surface 18 of the cutting element 21 is formed at an angle between 25 to 90° to a surface of said cutting element 21. Referring to FIG. 2, the elongated cutter wall 16 includes two cut-out portions 38 formed on an outside surface thereof adjacent the open drivable end 15. The cut-out portions 38 are for receiving the operable end of a drive device (not shown) in order to reciprocate the cutting member 14 and therefore the cutting element 21 up and down in cooperation with the extrusion die 22. The drive device can be any well known device for reciprocating the cutting member 14. It is also possible to provide a groove (not shown) around the outer circumference of the annular extrusion member 9 instead of the cut-out portions 38 as would be understood to one having ordinary skill in the art.

It is noted that the extrusion wall 10 and the cutter member 14 are illustrated having cooperating tubular shapes; however, it can be readily understood to one having ordinary skill in the art that they may be made in other cooperating shapes as well. All that is necessary is for the cutting member 14 to have an inside diameter of generally the same size and shape as the outside diameter and shape of the extrusion wall 10 to allow the cutting member 14 to reciprocate in a sliding manner on the outside of the extrusion wall 10.

Referring to the FIG. 3, a front view of the die 22 of the die and cutter assembly 1 of the present invention is illustrated. The die 22 includes at least one extrusion outlet 24, which in the illustrated embodiments are in the shape of a hexagon. However, the shape of the extrusion outlet is not limited to a hexagon. As long as there are several straight sides, then the advantages of the present invention can be realized. The extrusion outlet 24 extends through the die until it opens up into a cavity 26 formed in a rear side of the die 22. The provision of the cavity 26 provides a smooth transition for the mash to flow from inside of the annular extrusion member 9, into the cavity and out of the extrusion outlet.

It should be noted at this time that the shape of the extrusion outlet ensures that the extrudate exits the extrusion outlet 24, so that a straight stick shaped product is formed. The stick-shaped extrudate can then be cut to a desired size by the cutter member 14 to form a straight food product.

The operation of the die and cutter assembly of the present invention will now be described with reference to FIGS. 1-5. FIG. 2 illustrates the “ready to cut” state. In the “after cut” state, the cutter blade is located below the extrusion outlet, so that the extrudate is cut to a desired length (see FIG. 4). The mash is forced through the open feed end 12 of the extrusion member 9 from the pressure vessel for containing a mash of food while the cutter member 14 is in the upper position.

The mash is then forced into the cavity 26 formed in the rear of the die 22, and then through the extrusion outlet 24. Due to the shape of the extrusion outlet 24 and the pressure of the mash, the extrudate does not twist when exiting the die 22. Once a predetermined length of extrudate is fed through the extrusion die 22, the cutter member 14 is moved from the position illustrated in FIG. 2 downwardly to the position illustrated in FIG. 4 to cut the extrudate to the predetermined length. The movement of the cutter member drives the cutting surface of the cutting element into cooperation with the extrusion die in order to cut the extrudate.

The above operation occurs continuously with the extrudate exiting the extrusion die 22 and being cut by the reciprocating cutting member 14 in order to produce straight food products of a predetermined length.

The cutter member 14 is disposed at least partially over and reciprocally slideable on the tubular extrusion wall 10 and is operably connected at the drivable end 15 to a drive device for reciprocatably sliding the cutter member 14 over and away from the extrusion die 22. The rate of number of strokes per minute (down and up) at which the cutter member can operate can range from 80 strokes/minute through 500 strokes/minute.

The length of individual products extruded in accordance with the present invention will depend upon both the rate at which the cutter member operates and the rate at which the product is extruded, the latter being a function of the viscosity of the product in the pressure vessel and the pressure being applied to that product.

Referring to FIGS. 3 and 5, a cross-section of the die 22 according to the present invention is illustrated. As can be understood, the rear of the die 22 has a cavity 26 formed therein, so that a smooth flow of extrudate from the extrusion member 9 occurs. It should be noted that the size and shape of this cavity can be changed, depending on the application, in order to affect the extrudate exiting the extrusion outlet 24 of the extrusion die. In addition, the length and width of the extrusion outlet 24 can be changed to affect the extrudate in a similar manner. By controlling the shape, length and width of the extrusion outlet, as well as the consistency of the mash and the pressure of the mash, a very straight, stick-shaped food product can be obtained.

It should also be noted that the die 22 of the present invention could also be used in a co-extruder, such as the above mentioned U.S. Pat. No. 6,511,309 or 6,964,562. It is also within the scope of the present invention to use the die 22 of the present invention in a co-extruder described in U.S. application Ser. No. 12/425,032, filed on Apr. 16, 2009, which is incorporated herein by reference. In the '309 and '562 patents, the cutting assembly includes a filling tube, which enters the annular extrusion member from the top thereof, while in the '032 application, the filling tube enters the rear of the annular extrusion member. In any event, one having ordinary skill in the art would readily understand that the die 22 of the present invention would be capable of operating with any of the above-mentioned co-extruders. With such an arrangement, it is possible to accomplish a very straight, stick-shaped food product with a filling.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A cutter assembly for an extruder, comprising:
an elongated extrusion member having an open feed end, said open feed end being attachable in fluid communication with the extruder for supplying a mash to said elongated extrusion member;
an extrusion die supported on said elongated extrusion member, said extrusion die including at least one extrusion outlet formed therein; and
a cutter member having a drivable end and a cutter blade with a cutting surface for cutting extrudate to a desired length as the extrudate exits the extrusion die, said cutter member being operably connectable at the drivable end to a drive device of the extruder for reciprocatably sliding the cutting surface of the cutter blade over and away from the outlet of the extrusion die,
wherein said at least one extrusion outlet is shaped to have at least six straight sides, the shape of the at least one extrusion outlet ensuring that the mash exits the extrusion die in a straight orientation in order to form a straight food product.

2. The cutter assembly according to claim 1, wherein each of said plurality of extrusion outlets is in the shape of a hexagon having straight walls.

3. A method of making a straight food product, said method comprising the steps of:
providing an elongated extrusion member having an open feed end, said open feed end being attachable in fluid communication with an extruder for supplying a mash to said elongated extrusion member;
providing an extrusion die supported on said elongated extrusion member, said extrusion die including at least one extrusion outlet formed therein, said at least one extrusion outlet being shaped to have at least six straight sides, the shape of the at least one extrusion outlet ensuring that the mash exits the extrusion die in a straight orientation in order to form a straight food product;
providing a cutter member having a drivable end and a cutter blade with a cutting surface for cutting extrudate to a desired length as the extrudate exits the extrusion die, said cutter member being operably connectable at the drivable end to a drive device of the extruder for reciprocatably sliding the cutting surface of the cutter blade over and away from the outlet of the extrusion die; and
extruding the mash while ensuring that the mash maintains a straight orientation to form a straight food product.

4. The method according to claim 3, further comprising the step of shaping the at least one extrusion outlet in the shape of a hexagon having straight sides.
